(19) United States
(12) Patent Application Publication
(10) Pub. No.: US 2018/0324061 A1
(43) Pub. Date: Nov. 8, 2018

(54) DETECTING NETWORK FLOW STATES FOR NETWORK TRAFFIC ANALYSIS

(71) Applicant: ExtraHop Networks, Inc., Seattle, WA (US)

(72) Inventors: Bhushan Prasad Khanal, Seattle, WA (US); Eric Joseph Hammerle, Seattle, WA (US); Arindum Mukerji, Seattle, WA (US)

(21) Appl. No.: 15/585,887

(22) Filed: May 3, 2017

(51) Int. Cl. H04L 12/26

(52) U.S. Cl. CPC H04L 43/04; H04L 69/161; H04L 43/12; H04L 43/18

(57) ABSTRACT

Embodiments are directed to monitoring a network flow. A characteristic of the monitored network flow may be compared to a criterion. A filter may provide the criterion. Filtered network traffic may be provided based on the filter and the comparison. A rule may be provided based on the filtered network traffic, such that each rule is associated with one or more rule prologues and one or more rule actions. The one or more rule prologues may be executed on the filtered network traffic to provide one or more satisfied rule prologues. One or more of the one or more rule actions may be executed based on the one or more satisfied rule prologues, such that the one or more executed rule actions and the one or more satisfied rule prologues are each associated with a same rule.

### TECHNICAL FIELD

The present invention relates generally to network monitoring, and more particularly, but not exclusively, to monitoring network traffic in a distributed network environment.

### BACKGROUND

On most computer networks, bits of data arranged in bytes are packaged into collections of bytes called packets. These packets are generally communicated between computing devices over networks in a wired and/or wireless manner. A suite of communication protocols is typically employed to communicate between at least two endpoints over one or more networks. The protocols are typically layered on top of one another to form a protocol stack. One model for a network communication protocol stack is the Open Systems Interconnection (OSI) model, which defines seven layers of different protocols that cooperatively enable communication over a network. The OSI model layers are arranged in the following order: Physical (1), Data Link (2), Network (3), Transport (4), Session (5), Presentation (6), and Application (7).

Another model for a network communication protocol stack is the Internet Protocol (IP) model, which is also known as the Transmission Control Protocol/Internet Protocol (TCP/IP) model. The TCP/IP model is similar to the OSI model except that it defines four layers instead of seven. The TCP/IP model's four layers for network communication protocol are arranged in the following order: Link (1), Internet (2), Transport (3), and Application (4). To reduce the number of layers from seven to four, the TCP/IP model collapses the OSI model's Application, Presentation, and Session layers into the TCP/IP's Application layer. Also, the OSI's Physical layer is either assumed or is collapsed into the TCP/IP model's Link layer. Although some communication protocols may be listed at different numbered or named layers of the TCP/IP model versus the OSI model, both of these models describe stacks that include basically the same protocols. For example, the TCP protocol is listed on the fourth layer of the OSI model and on the third layer of the TCP/IP model.

To assess and troubleshoot communicated packets and protocols over a network, different types of network monitors can be employed. One type of network monitor, a “packet sniffer” may be employed to generally monitor and record packets of data as they are communicated over a network. Some packet sniffers can display data included in each packet and provide statistics regarding a monitored stream of packets. Also, some types of network monitors are referred to as “protocol analyzers” in part because they can provide additional analysis of monitored and recorded packets regarding a type of network, communication protocol, or application.

Generally, packet sniffers and protocol analyzers passively monitor network traffic without participating in the communication protocols. In some instances, they receive a copy of each packet on a particular network segment or virtual local area network (VLAN) from one or more members of the network segment. They may receive these packet copies through a port mirror on a managed Ethernet switch, e.g., a Switched Port Analyzer (SPAN) port, a Roving Analysis Port (RAP), or the like, or combinations thereof. Port mirroring enables analysis and debugging of network communications. Port mirroring can be performed for inbound or outbound traffic (or both) on single or multiple interfaces. In other instances, packet copies may be provided to the network monitors from a specialized network tap or from a software agent running on a client or server. In virtual environments, port mirroring may be performed on a virtual switch that is incorporated within a hypervisor.

In some instances, a proxy is actively arranged between two endpoints, such as a client device and a server device. The proxy intercepts each packet sent by each endpoint and optionally transforms and forwards a payload to the other endpoint. Proxies often enable a variety of additional services such as load balancing, caching, content filtering, and access control. In some instances, a proxy may operate as a network monitor. In other instances, the proxy may forward a copy of the packets to a separate network monitor.

However, effectively monitoring the increasing amount of data communicated over networks may be challenging. Accordingly, packets and/or portions of packets may be selectively monitored to reduce performance requirements for monitoring devices. In addition, as information technology infrastructure becomes more complex and more dynamic, there be may numerous packet types and formats for various different types of network protocols and applications that may be carried on modern networks that may it difficult for effective network monitoring. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of the Various Embodiments, which is to be read in association with the accompanying drawings, wherein:

FIG. 1 illustrates an exemplary system environment in which various embodiments may be implemented;

FIG. 2 shows an exemplary schematic embodiment of an exemplary client computer;

FIG. 3 illustrates an exemplary schematic embodiment of an exemplary network computer;

FIG. 4 shows a logical architecture of an exemplary system for monitoring network traffic, filtering the network traffic, and acting in accordance with various rules;

FIG. 5 illustrates a logical sequence diagram representing an exemplary sequence that includes one or more turns;

FIG. 6 shows an overview flowchart of an exemplary process for monitoring network traffic;

FIG. 7 illustrates a logical flow diagram of an exemplary process for applying one or more filters to monitored network traffic;

FIG. 8 shows a logical flow diagram of an exemplary process for employing one or more rule engines;

FIG. 9 illustrates a logical flow diagram of an exemplary process for employing one or more rule engines that detect turns; and

FIG. 10 shows a logical flow diagram of an exemplary process for employing one or more rule engines that detect anomalies.

### DETAILED DESCRIPTION OF THE VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” Also, throughout the specification and the claims, the use of “when” and “responsive to” do not imply that associated resultant actions are required to occur immediately or within a particular time period. Instead, they are used herein to indicate actions that may occur or be performed in response to one or more conditions being met, unless the context clearly dictates otherwise. Additionally, throughout the specification, the use of “exemplary” does not imply that other embodiments do not perform as well or are not as worthy of illustration. Instead, the term is used herein to emphasize that each element or function described by the term is an example element or function.

For example embodiments, the following terms are also used herein according to the corresponding meaning, unless the context clearly dictates otherwise.

As used herein, the term “session” refers to a semi-permanent interactive packet interchange between two or more communicating endpoints, such as network devices. A session is set up or established at a certain point in time and torn down at a later point in time. An established communication session may involve more than one message in each direction. A session may have stateful communication where one or more communicating network devices saves information about a session history to communicate with another of the endpoints. A session may also provide stateless communication where communicating network devices communicate with independent requests and responses between the endpoints. An established session is a basic requirement to perform a connection-oriented communication. A session also is a basic step to transmit in connectionless communication modes.

As used herein, the terms “network connection” and “connection” refer to a communication session with a semi-permanent connection for interactive packet interchange between two or more communicating endpoints, such as network devices, where a stream of data is delivered in the same or different order than it was sent. The connection may be established before application data is transferred. An alternative to connection-oriented transmission is connectionless communication. For example, a datagram mode of communication used by the Internet Protocol (IP) and the Universal Datagram Protocol (UDP), which may deliver packets out of order because different packets may be routed independently and could be delivered over different paths. Packets associated with a TCP protocol connection may also be routed independently and could be delivered over different paths. However, for TCP connections, a network communication system may provide packets to application endpoints in the same order that they were sent.

Connection-oriented communication may be a packet-mode virtual circuit connection. For example, a transport layer virtual circuit protocol such as the TCP protocol can deliver packets of data in order although lower layer switching may be connectionless. A connection-oriented transport layer protocol such as TCP can also provide connection-oriented communications over connectionless communication. For example, if TCP is based on a connectionless network layer protocol (such as IP), this TCP/IP protocol can then achieve in-order delivery of a byte stream of data, e.g., by means of segment sequence numbering on a sender side and packet buffering and data packet reordering on a receiver side. Alternatively, a virtual circuit connection may be established in a datalink layer or network layer switching mode where all data packets belonging to the same traffic stream are delivered over the same path and where traffic flows are identified by some connection identifier rather than by complete routing information, which enables fast hardware-based switching.

As used herein, the terms “session flow” and “network flow” refer to one or more network packets or a stream of network packets that are communicated in a session that is established between at least two endpoints, such as two network devices. In at least one of the various embodiments, flows may be useful if one or more endpoints of a session may be behind a network traffic management device, such as a firewall, switch, router, load balancer, or the like. In at least one of the various embodiments, such flows may be used to ensure that packets sent between endpoints of a flow may be routed appropriately.

Typically, establishing a TCP based connection between endpoints begins with execution of an initialization protocol and creates a single bi-directional flow between two endpoints, e.g., one direction of flow going from endpoint A to endpoint B while the other direction of the flow goes from endpoint B to endpoint A where each endpoint is at least identified by an IP address and a TCP port.

Also, some protocols or network applications may establish a separate flow for control information that enables management of at least one or more flows between two or more endpoints. Further, in some embodiments, network flows may be half-flows that may be unidirectional.

As used herein, the terms “tuple,” “tuple information” refer to a set of values that identify a source and destination of a network packet, which may, under some circumstances, be a part of a network connection. In one embodiment, a tuple may include a source Internet Protocol (IP) address, a destination IP address, a source port number, a destination port number, virtual LAN segment identifier (VLAN ID), tunnel identifier, routing interface identifier, physical interface identifier, or a protocol identifier. Tuples may be used to identify network flows.

As used herein the term “related flows” or “related network flows” as used herein are network flows that, while separate, are operating cooperatively. For example, some protocols, such as File Transfer Protocol (FTP), Session Initiation Protocol (SIP), Real-time Transport Protocol (RTP), Voice over Internet Protocol (VOIP), custom protocols, or the like, may provide control communication over one network flow and data communication over other network flows. Further, configuration rules may define one or more criteria that are used to recognize that two or more network flows should be considered related flows. For example, configuration rules may define that flows containing a particular field value should be grouped with other flows having the same field value, such as a cookie value, or the like.

As used herein, the terms “network monitor,” “network monitoring computer,” or “NMC” refer to an application (software, hardware, or some combination) that is arranged to monitor and record flows of packets in a session that are communicated between at least two endpoints over at least one network. The NMC can provide information for assessing different aspects of these monitored flows. In at least one embodiment, the NMC may passively monitor network packet traffic without participating in communication protocols. This monitoring may be performed for a variety of reasons, including troubleshooting and proactive remediation, end-user experience monitoring, Service Level Agreement (SLA) monitoring, capacity planning, application lifecycle management, infrastructure change management, infrastructure optimization, business intelligence, security, and regulatory compliance. The NMC can receive network communication for monitoring through a variety of means including network taps, wireless receivers, port mirrors, or directed tunnels from network switches, clients, or servers including the endpoints themselves or other infrastructure devices. In at least some of the various embodiments, the NMC may receive a copy of each packet on a particular network segment or virtual local area network (VLAN). Also, for at least some of the various embodiments, they may receive these packet copies through a port mirror on a managed Ethernet switch, e.g., a Switched Port Analyzer (SPAN) port, a Roving Analysis Port (RAP), or the like, or combination thereof. Port mirroring enables analysis and debugging of network communications. Port mirroring can be performed for inbound or outbound traffic (or both) on single or multiple interfaces.

The NMC may track network connections from and to end points such as a client and/or a server. The NMC may also extract information from packets including protocol information at various layers of a communication protocol stack. The NMC may reassemble or reconstruct a stream of data exchanged between endpoints. The NMC may perform decryption of a payload at various layers of a protocol stack. The NMC may passively monitor network traffic or it may participate in protocols as a proxy. The NMC may attempt to classify network traffic according to communication protocols that are used by the traffic.

The NMC may also perform one or more actions for classifying protocols that may be a necessary precondition for application classification. While some protocols run on well-known ports, others do not. Also, even if there is traffic on a well-known port, it is not necessarily a protocol generally understood to be assigned to that port. As a result, the NMC may perform protocol classification using one or more techniques, such as signature matching, statistical analysis, traffic analysis, and other heuristics. In some cases, the NMC may use adaptive protocol classification techniques where information used to classify protocols may be accumulated and/or applied over time to further classify observed protocols. In some embodiments, NMCs may be arranged to employ stateful analysis. Accordingly, for each supported protocol, the NMC may use network packet payload data to drive a state machine that mimics protocol state changes in client/server flows being monitored. The NMC may categorize traffic where categories might include file transfers, streaming audio, streaming video, database access, interactive, gaming, and the like. The NMC may attempt to determine whether traffic corresponds to known communications protocols, such as Hypertext Transfer Protocol (HTTP), FTP, Simple Mail Transfer Protocol (SMTP), RTP, Tabular Data Stream (TDS), TCP, IP, and the like.

In at least one of the various embodiments, NMCs and/or NMC functionality may be implemented using hardware or software based proxy devices that may be arranged to intercept network traffic in monitored networks.

As used herein, the terms “layer” and “model layer” refer to a layer of one or more communication protocols in a stack of communication protocol layers that are defined by a model, such as the OSI model and the TCP/IP (IP) model. As explained above, the OSI model defines seven layers and the TCP/IP model defines four layers of communication protocols.

For example, at the OSI model's lowest or first layer (Physical), streams of electrical/light/radio impulses (bits) are communicated between computing devices over some type of media, such as cables, network interface cards, radio wave transmitters, and the like. At the next or second layer (Data Link), bits are encoded into packets and packets are also decoded into bits. The Data Link layer also has two sub-layers, a Media Access Control (MAC) sub-layer and a Logical Link Control (LLC) sub-layer. The MAC sub-layer controls how a computing device gains access to data and permission to transmit it. The LLC sub-layer controls frame synchronization, flow control, and error checking. At the third layer (Network), logical paths are created, known as virtual circuits, to communicated data from node to node. Routing, forwarding, addressing, internetworking, error handling, congestion control, and packet sequencing are functions of the Network layer. At the fourth layer (Transport), transparent transfer of data between end computing devices, or hosts, is provided. The Transport layer is responsible for end to end recovery and flow control to ensure complete data transfer over a network.

At the fifth layer (Session) of the OSI model, connections between applications are established, managed, and terminated. The Session layer sets up, coordinates, and terminates conversations, exchanges, and dialogues between applications at each end of a connection. At the sixth layer (Presentation), independence from differences in data representation, e.g., encryption, is provided by translating from application to network format and vice versa. Generally, the

Presentation layer transforms data into a form that protocols at the Application layer (7) can accept. For example, the Presentation layer generally handles formatting and encrypting/decrypting of data that is communicated across a network.

At the top or seventh layer (Application) of the OSI model, application and end user processes are supported. For example, communication partners may be identified, quality of service can be identified, user authentication and privacy may be considered, and constraints on data syntax can be identified. Generally, the Application layer provides services for file transfer, messaging, and displaying data. Protocols at the Application layer include FTP, HTTP, and Telnet.

As explained above, to reduce the number of layers from seven to four, the TCP/IP model collapses the OSI model's Application, Presentation, and Session layers into its Application layer. As also explained above, the OSI's Physical layer is either assumed or may be collapsed into the TCP/IP model's Link layer. Although some communication protocols may be listed at different numbered or named layers of the TCP/IP model versus the OSI model, both of these models describe stacks that include basically the same protocols.

As used herein, the terms “network flow turn,” “flow turn,” and “turn” refer to the instant when a network flow changes direction. NMCs may be arranged to implement traffic analysis that includes turn detection. Turn detection may include analyzing a monitored flow to determine if data is flowing in one direction (e.g., from network endpoint A to network endpoint B) followed by data flowing in the other direction (e.g., from network endpoint B to network endpoint A). This change of flow direction may, for some protocols, indicate a request-response pattern. In other protocols every other turn may correspond to a new transaction. If a turn is detected, an NMC may be arranged to search for a known sequence or pattern that corresponds to a protocol request or response at a beginning of a turn. NMCs may be configured to use various metrics for identifying a turn, such as changes in traffic flow rate, changes in traffic flow value, sequence matching, response delay/latency, or the like, or combination thereof. Accordingly, one or more threshold values may be configured for detecting turns. Also, knowledge of a particular protocol, application, or the like, may be employed using rules/conditions to help detect turns. In some embodiments, one or more metrics, threshold values, rules, or the like, may be combined together to provide heuristics that may be used for detecting turns.

As used herein, the term “filters” refers to classifiers comprised of expressions that include criteria that is arranged to be applied to network traffic without deep analysis of the network traffic. Filters may include high performant comparisons, such as comparing easily observable values in network traffic to defined or known values. For example, filter expressions may include expressions for identifying network addresses, ports, protocol header values, new network traffic, trusted network traffic, new protocols, new devices, trusted devices, new ports, trusted ports, quality-of-service (QoS), or the like.

Also as used herein, the term “rule” refers to an object or data structure that is associated with one or more rule prologues and one or more actions. Rules may be considered to be arbitrarily complex. They may comprise various instructions, configuration information, or the like, that enable the various actions to be selectively applied to monitored network traffic. Rules may be comprised of instructions defined using scripts, programs, configuration information, Application Specific Integrated Circuits (ASICs), Field Programmable Gate Arrays (FPGAs), Programmable Array Logics (PALs), or the like. Various portions of a rule, such as, one or more rule prologues, one or more rule actions, or the like, may be associated with each other and included in the same database table, one or more separate tables (e.g., one table for rule prologues and one table for rule actions, or the like), the same file, separate files, or the like, or combination thereof. Examples of rules include turn-detection rules, state machine rules, tunneled-protocol-detection rules, signature-analysis rules, pattern-detection rules, pipelining-detection rules, encryption-detection rules, type-of-service-detection rules, envelope-tracking rules, string-comparison rules, regex-comparison rules, or the like.

Also as used herein, the term “rule prologue” refers to one or more criteria that is arranged to be applied by a rule engine to determine if one or more defined actions should be performed based on the monitored network traffic. Rule prologues may be arranged to refer to single network packets, multiple network packets, related network flows, or the like.

As used herein, the term “rule action” refers to one or more actions to be taken when one or more characteristics of the network traffic satisfy a rule prologue of the rule associated with the rule action. Typically, rules are more computationally expensive than filters.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to monitoring one or more network flows. In one or more of the various embodiments, a filter engine may apply filters to network traffic in the one or more monitored network flows to filter the network traffic based on characteristics of the network traffic. In some of the various embodiments, each filter may provide one or more criteria. In some embodiments, when one or more characteristics of the network traffic match one or more of the criteria or combinations of the criteria, the filtered network traffic may be provided to a rule engine. In some embodiments, employing the filter engine may be less computationally expensive than employing the rule engine.

In one or more of the various embodiments, the filter engine may apply rules to the filtered network traffic. In some of the various embodiments, the filter engine may select which rules to apply based on the filtered network traffic, such as based on which one or more filters or combinations of filters have one or more criteria that matched one or more characteristics of the filtered network traffic. In some of the various embodiments, each rule may have one or more rule prologues and one or more rule actions. In some embodiments, the rule engine may execute the one or more rule prologues on the filtered network traffic. In some embodiments, when the filtered network traffic satisfies one or more executed rule prologues or combinations of executed rule prologues, the rule engine may execute one or more rule actions of the one or more rules associated with the one or more satisfied rule prologues.

In one or more of the various embodiments, the one or more executed rule actions may include providing the filtered network traffic to one or more other engines for further analysis. In some of the various embodiments, employing the filter engine and the rule engine may be computationally less expensive than employing the one or more other engines.

Also briefly stated, various embodiments are directed to monitoring one or more network flows. In one or more of the various embodiments, one or more characteristics of the one or more monitored network flows may be compared to one or more criteria, such that the one or more criteria are provided by one or more filters.

In one or more of the various embodiments, filtered network traffic may be provided based on the one or more filters and the comparison.

In one or more of the various embodiments, one or more rules may be provided based on the filtered network traffic, such that each rule is associated with one or more rule prologues and one or more rule actions.

In one or more of the various embodiments, the one or more rule prologues may be executed on the filtered network traffic to provide one or more satisfied rule prologues.

Accordingly, one or more of the one or more rule actions may be executed based on the one or more satisfied rule prologues, such that the one or more executed rule actions and the one or more satisfied rule prologues are each associated with a same rule.

In one or more of the various embodiments, providing the one or more rules may include providing the one or more rules based on which of the one or more filters are associated with the filtered network traffic.

In one or more of the various embodiments, the one or more criteria provided by the one or more filters include one or more discoveries of one or more new network flows or one or more new network devices on a monitored network.

In one or more of the various embodiments, executing the one or more rule prologues on the filtered network traffic may include inspecting payload contents of one or more network packets that are included in the filtered network traffic.

In one or more of the various embodiments, executing the one or more rule prologues on the filtered network traffic may include executing one or more turn detection rules.

In one or more of the various embodiments, executing the one or more rule prologues on the filtered network traffic may include employing one or more state machines to compare one or more state transitions in the filtered network traffic to one or more expected state transitions.

In one or more of the various embodiments, the one or more criteria provided by the one or more filters may include one or more of a network protocol, an application protocol, an application type, a traffic rate, or tuple information of the one or more monitored network flows.

In one or more of the various embodiments, executing the one or more of the one or more rule actions may include providing one or more portions of the filtered network traffic to one or more universal payload analysis (UPA) engines.

### Illustrative Operating Environment

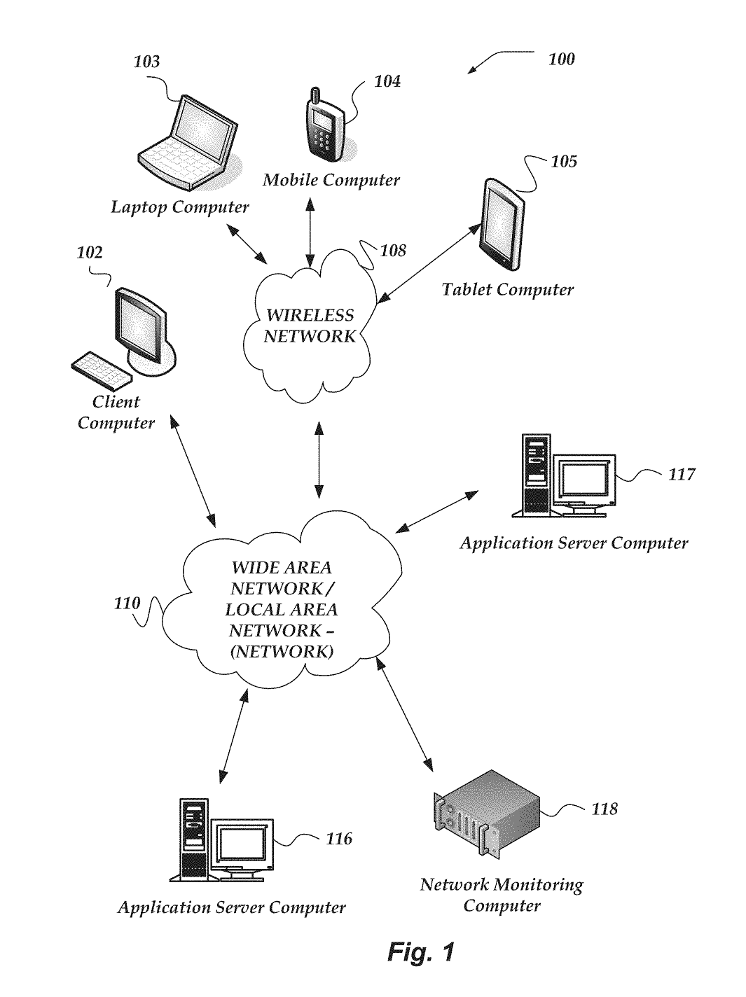

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, Application Server Computer 116, Application Server Computer 117, Network monitoring computer 118, or the like.

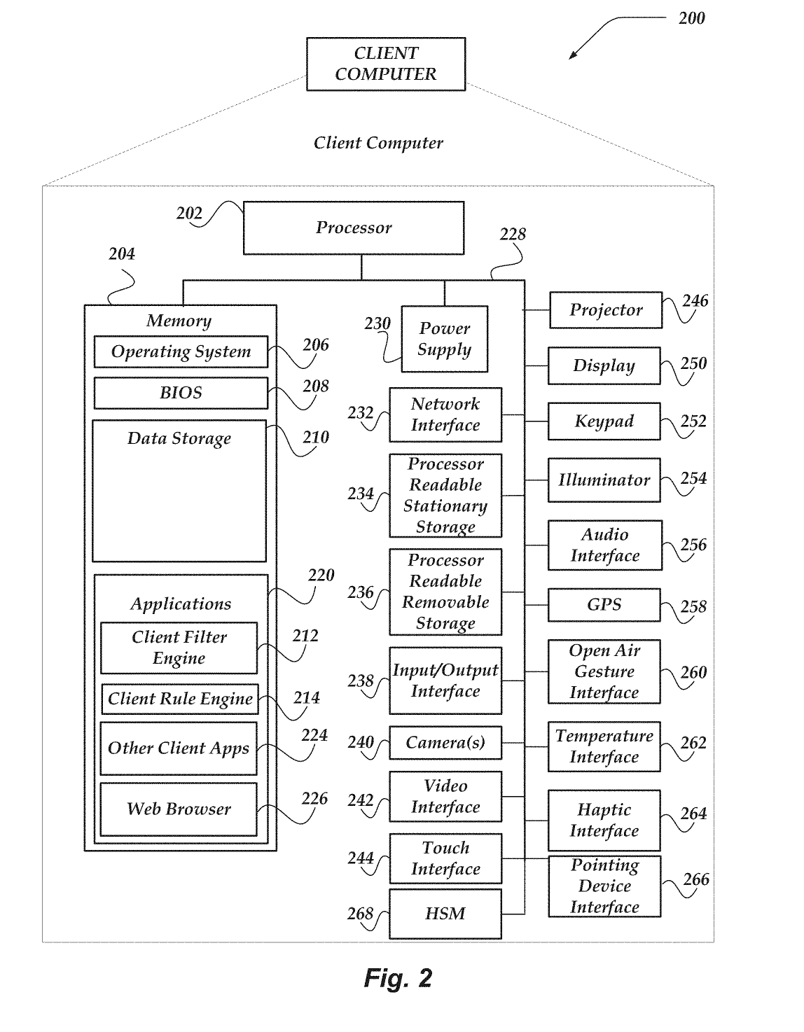

At least one embodiment of client computers 102-105 is described in more detail below in conjunction with FIG. 2. In one embodiment, at least some of client computers 102-105 may operate over one or more wired and/or wireless networks, such as networks 108, and/or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information, such as laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, application server computer 116, application server computer 117, network monitoring computer 118, or other computers.

Client computers 102-105 may further be configured to include a client application that enables an end-user to log into an end-user account that may be managed by another computer, such as application server computer 116, application server computer 117, network monitoring computer 118, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Further, client computers may be arranged to enable users to provide configuration information, or the like, to network monitoring computer 118. Also, client computers may be arranged to enable users to display reports, interactive user-interfaces, and/or results provided by network monitoring computer 118.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, application server computer 116, application server computer 117, network monitoring computer 118, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

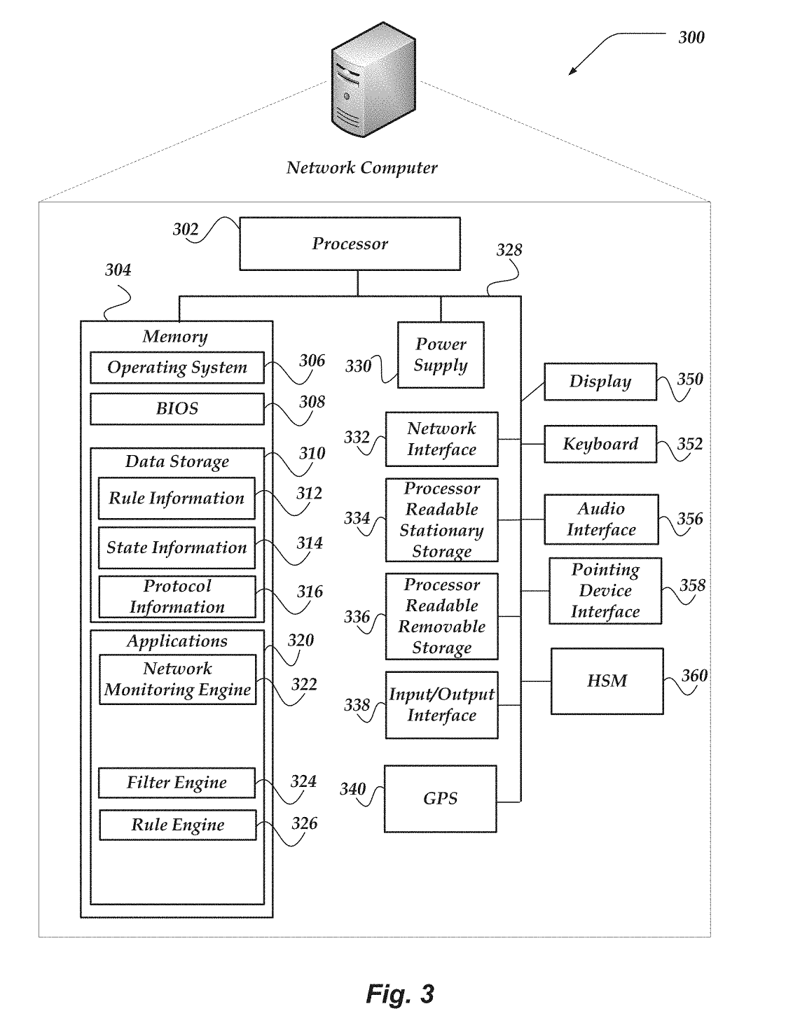

One embodiment of application server computer 116 and/or application server computer 117 is described in more detail below in conjunction with FIG. 3. Briefly, however, application server computer 116-117 includes virtually any network computer capable of hosting applications and/or providing services in network environment.

One embodiment of network monitoring computer 118 is described in more detail below in conjunction with FIG. 3. Briefly, however, network monitoring computer 118 may include virtually any network computer capable of passively monitoring communication traffic and/or capturing network packets in a network environment.

Although FIG. 1 illustrates application server computer 116, application server computer 117, and network monitor device 118, each as a single computer, the innovations and/or embodiments are not so limited. For example, one or more functions of application server computers 116-117, and/or network monitoring computer 118, or the like, may be distributed across one or more distinct network computers. Moreover, in at least one embodiment, network monitoring computer 118 may be implemented using a plurality of network computers. Further, in at least one of the various embodiments, application server computers 116-117, and/or network monitoring computer 118 may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, at least one embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring and/or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to event messages. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing and/or using security/cryptographic information, such as keys, digital certificates, passwords, passphrases, two-factor authentication information, or the like. In some embodiments, hardware security module may be employed to support one or more standard public key infrastructures (PKI), and may be employed to generate, manage, and/or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, Wi-Fi™, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input and/or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In at least one embodiment, however, client computer 200 may, through other components, provide other information that may be employed to determine a physical location of the client computer, including for example, a Media Access Control (MAC) address, IP address, and the like.

Human interface components can be peripheral devices that are physically separate from client computer 200, allowing for remote input and/or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, and/or otherwise process instructions and data. Applications 220 may include, for example, client filter engine 212, client rule engine 214, other client applications 224, web browser 226, or the like. Client computers may be arranged to exchange communications, such as queries, searches, messages, notification messages, event messages, alerts, performance metrics, log data, API calls, or the like, combination thereof, with application servers and/or network monitoring computers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include one or more embedded logic hardware devices instead of one or more CPUs, such as an Application Specific Integrated Circuits (ASICs), Field Programmable Gate Arrays (FPGAs), Programmable Array Logics (PALs), or the like, or combination thereof. The one or more embedded logic hardware devices may directly execute embedded logic to perform actions. Also, in one or more embodiments (not shown in the figures), client computer 200 may include one or more hardware microcontrollers instead of one or more CPUs. In at least one embodiment, the one or more microcontrollers may directly execute their own embedded logic to perform actions and access its own internal memory and its own external Input and Output Interfaces (e.g., hardware pins and/or wireless transceivers) to perform actions as a System On a Chip (SOC), or the like.

### Illustrative Network Computer

FIG. 3 shows one embodiment of network computer 300 that may be included in a system implementing at least one of the various embodiments. Network computer 300 may include many more or less components than those shown in FIG. 3. However, the components shown are sufficient to disclose an illustrative embodiment for practicing these innovations. Network computer 300 may represent, for example, one embodiment of at least one of application server computers 116-117 and/or network monitoring computer 118 of FIG. 1.

As shown in the figure, network computer 300 includes a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. Display 350 may be a handheld projector or pico projector capable of projecting an image on a wall or another object.

Network computer 300 may also comprise input/output interface 338 for communicating with external devices or computers not shown in FIG. 3. Input/output interface 338 can utilize one or more wired or wireless communication technologies, such as USB™, Firewire™, Wi-Fi™, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to network computer 300. Human interface components can be physically separate from network computer 300, allowing for remote input and/or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In at least one embodiment, however, network computer 300 may, through other components, provide other information that may be employed to determine a physical location of the client computer, including for example, a Media Access Control (MAC) address, IP address, and the like.

Memory 304 may include Random Access Memory (RAM), Read-Only Memory (ROM), and/or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs. Likewise, other runtime environments may be included.

Memory 304 may further include one or more data storage 310, which can be utilized by network computer 300 to store, among other things, applications 320 and/or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, rule information 312, state information 314, protocol information 316, or the like. Rule information 312 may be a data store that contains one or more rules, filters, or the like, that may be employed during monitoring of the networks. State information 314 represents a data store that may be used for tracking protocol or application state. In some embodiments, state information 314 may include state machines, or state information for monitoring various communication protocols, network applications, network services, or the like. And, protocol information 316 may store various rules and/or configuration information related to one or more network communication protocols that may be employed on monitored networks, or the like.

Applications 320 may include computer executable instructions which, when executed by network computer 300, transmit, receive, and/or otherwise process messages (e.g., SMS, Multimedia Messaging Service (MMS), Instant Message (IM), email, and/or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, databases, web services, and so forth. Applications 320 may include network monitoring engine 322, filter engine 324, and rule engine 326 that perform actions further described below. In at least one of the various embodiments, one or more of the applications may be implemented as modules and/or components of another application. Further, in at least one of the various embodiments, applications may be implemented as operating system extensions, modules, plugins, or the like.

Furthermore, in at least one of the various embodiments, network monitoring engine 322, filter engine 324, and rule engine 326 may be operative in a cloud-based computing environment. In at least one of the various embodiments, these engines, and others, that comprise the management platform may be executing within virtual machines and/or virtual servers that may be managed in a cloud-based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines and/or virtual servers dedicated to network monitoring engine 322, filter engine 324, or rule engine 326 may be provisioned and de-commissioned automatically.

Also, in at least one of the various embodiments, network monitoring engine 322, filter engine 324, rule engine 326, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing and/or using security/cryptographic information, such as keys, digital certificates, passwords, passphrases, two-factor authentication information, or the like. In some embodiments, hardware security module may be employ to support one or more standard public key infrastructures (PKI), and may be employed to generate, manage, and/or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include one or more embedded logic hardware devices instead of one or more CPUs, such as an Application Specific Integrated Circuits (ASICs), Field Programmable Gate Arrays (FPGAs), Programmable Array Logics (PALs), or the like, or combination thereof. The one or more embedded logic hardware devices may directly execute embedded logic to perform actions. Also, in one or more embodiments (not shown in the figures), network computer 300 may include one or more hardware microcontrollers instead of one or more CPUs. In at least one embodiment, the one or more microcontrollers may directly execute their own embedded logic to perform actions and access its own internal memory and its own external Input and Output Interfaces (e.g., hardware pins and/or wireless transceivers) to perform actions as a System On a Chip (SOC), or the like.

### Illustrative Logical System Architecture

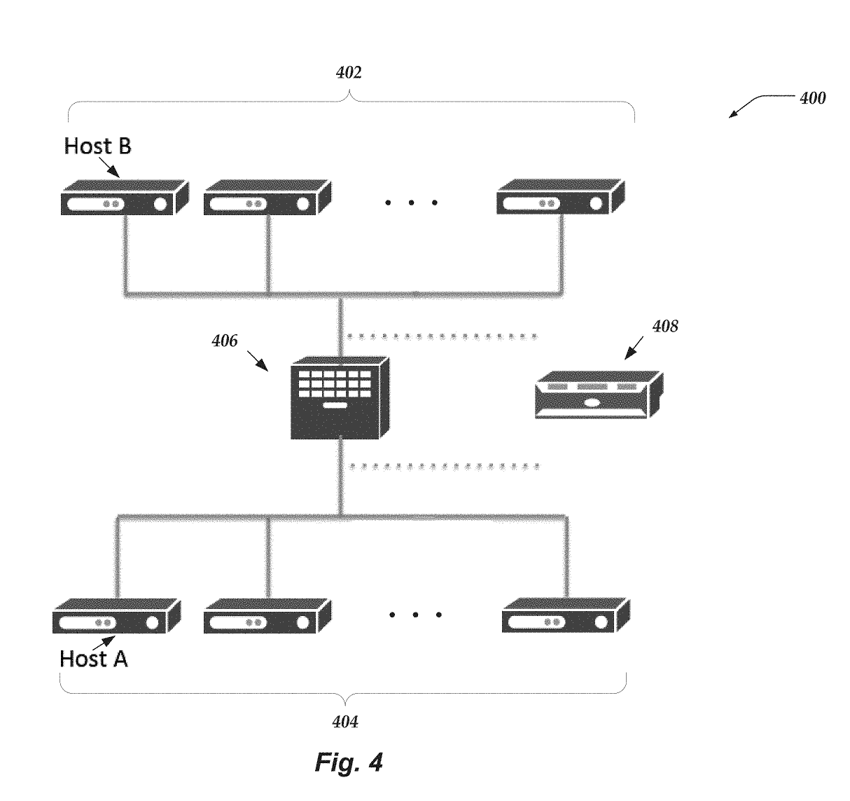

FIG. 4 shows a logical architecture of exemplary system 400 for monitoring network traffic, filtering the network traffic, and acting in accordance with various rules. System 400 may be arranged to include a plurality of network devices or network computers on first network 402 and a plurality of network devices or network computers on second network 404. Communication between the first network and the second network is managed by switch 406. Also, NMC 408 may be arranged to passively monitor or capture packets (network packets) communicated in network connection flows between network devices or network computers on first network 402 and second network 404. For example, the communication of flows of packets between the Host B network computer and the Host A network computer are managed by switch 406, and NMC 408 may be passively monitoring and recording some or all of the network traffic comprising these flows.

Also, NMC 408 or other NMCs may be arranged to passively monitor network communication between and among hosts that are on the same network, such as network computers 402.

NMC 408 may be arranged to receive network traffic for monitoring through a variety of means including network taps, wireless receivers, port mirrors or directed tunnels from network switches, clients or servers including the endpoints themselves, or other infrastructure devices. In some of the various embodiments, the NMC may receive a copy of each packet on a particular network segment or virtual local area network (VLAN). Also, for some of the various embodiments, NMCs may receive these packet copies through a port mirror on a managed Ethernet switch, e.g., a Switched Port Analyzer (SPAN) port, or a Roving Analysis Port (RAP). Port mirroring enables analysis and debugging of network communications. Port mirroring can be performed for inbound or outbound traffic (or both) on single or multiple interfaces.

In at least one of the various embodiments, NMCs, such as NMC 408, may be arranged to capture data from some or all observed network flows. In one or more of the various embodiments, some or all of the captured packets may be stored at the NMC. In some embodiments, the some or all of the captured packets may be stored on a data storage remote from the NMC that captured the packets.

In some of the various embodiments, an NMC, such as NMC 408 may be arranged to passively observe both directions of network flows. Accordingly, an NMC may be arranged to observe the network conversation between different endpoints in the monitored network. In some embodiments, NMCs may be arranged to monitor both directions of transaction based traffic between endpoints. Accordingly, in some of the various embodiments, NMCs may be arranged to identify network flows that may be using request/response protocols.

In some of the various embodiments, NMC may be arranged to monitor both directions of communication of network flow to determine if a turn has occurred. As defined above, refers to the instant when a network flow changes direction. In some embodiments, the NMC may be arranged to observe when servers acknowledge and respond to requests from clients. NMCs may be arranged to employ configuration and/or rules that are used to determine if there is a turn. In some embodiments, the NMCs may track protocol state information for both ends of a network flow to identify turns. For example, common network protocols, such as TCP have well known transactional behavior that may be observed by an NMC.

As described above, in some of the various embodiments, NMCs may be arranged to monitor network flows to observe and/or record various metrics associated with the flow traffic. In some embodiments, metrics, such as traffic rate, changes in traffic rate, latency, traffic volume, or the like, or combination thereof, may be employed to identify turns. Further, since the NMC has access to the wire traffic, it has access to the entire OSI layer stack. Accordingly, metrics collected at lower layers may be correlated with information from higher layers to characterize network traffic and identify turns.

Further, in some embodiments, NMCs may be arranged to recognize and understand various well-known application level protocols, such as HTTP, SMTP, FTP, DNS, POP3, IMPAP, or the like. Accordingly, in at least one of the various embodiments, NMCs may observe communication between clients and servers and use rules to identify if a turn may be occurring.

Further, in some of the various embodiments, NMCs may be arranged to discover network applications, such as databases, media servers (e.g., video streaming, music streaming, or the like), video conferencing/chatting, VOIP applications, web servers, or the like. Thus, in some embodiments, NMCs may be arranged to monitor the traffic of network flows in the context of the particular applications. Accordingly, in some of the various embodiments, NMCs may be arranged to employ rules or conditions to identify if a turn occurs based on a contextual understanding of the network application. For example, in some embodiments, a NMC may be arranged to identify that a network computer in the network (endpoint B) may be hosting a database application. Accordingly, if the NMC observes endpoint A sending a database query to endpoint B, endpoint B′s response may indicate a turn has occurred.

Accordingly, in some of the various embodiments, NMCs may be configured to selectively apply rules to monitored network traffic based on the occurrence of network flow turns. In some embodiments, for some applications, it may be understood that the network traffic occurring near a turn that may be of interest to real-time or forensic network packet analysis.

For example, network traffic near the turn may include a client's request and the initial responses of the server. Thus, in at least one of the various embodiments, it may be advantageous to increase the detail or select particular rules to monitor network traffic near turns so a more complete monitoring of the most interesting part of the network transaction may be performed. Likewise, in some embodiments, it may be advantageous to reduce the level or analysis or monitoring for traffic unassociated with a turn.

For example, if a client provides a request to download a 5GB video from server, the client's request and the initial response from the server may be interesting. It may be of interest because it may include the client request parameters, credentials, and so on, while the initial server response may include error response, acknowledgments, authentication results, or the like. Whereas, in this example, once the video begins downloading, the gigabytes of payload associated with the requested video may not be of much interest for the purposes of monitoring network performance.

In some of the various embodiments, NMCs may be arranged to employ various conditions, rules, pattern matching, heuristics, or the like, or combination thereof, implemented using scripts, compiled computer languages, ASICs, FGPAs, PALs, or the like, or combination thereof. In some embodiments, NMCs may be arranged include one or more conditions, rules, pattern matching, heuristics, or the like, that may be arranged to identify protocols, applications, turns, or the like, for various known network protocols, application protocols, network applications, or the like. Also, in some of the various embodiments, NMCs may be arranged enable user to install additional custom/specialized conditions, rules, pattern matching, heuristics, or the like, to identify other protocols, applications, network applications, turns, and so on.

In one or more of the various embodiments, NMCs may be arranged to filter the network traffic based on one or more filters before applying various rules to the filtered network traffic, such as the rules discussed above. In some of the various embodiments, NMCs may apply the filters to flows from new devices or applications. In some embodiments, NMCs may be arranged to filter the network traffic based on traffic type (e.g., new traffic, trusted traffic, or the like), protocol type (e.g., known protocol, unknown protocol, new protocol, or the like), device type (e.g., known device, unknown device, new device, or the like), ports, change in quality of service (QoS), or the like.

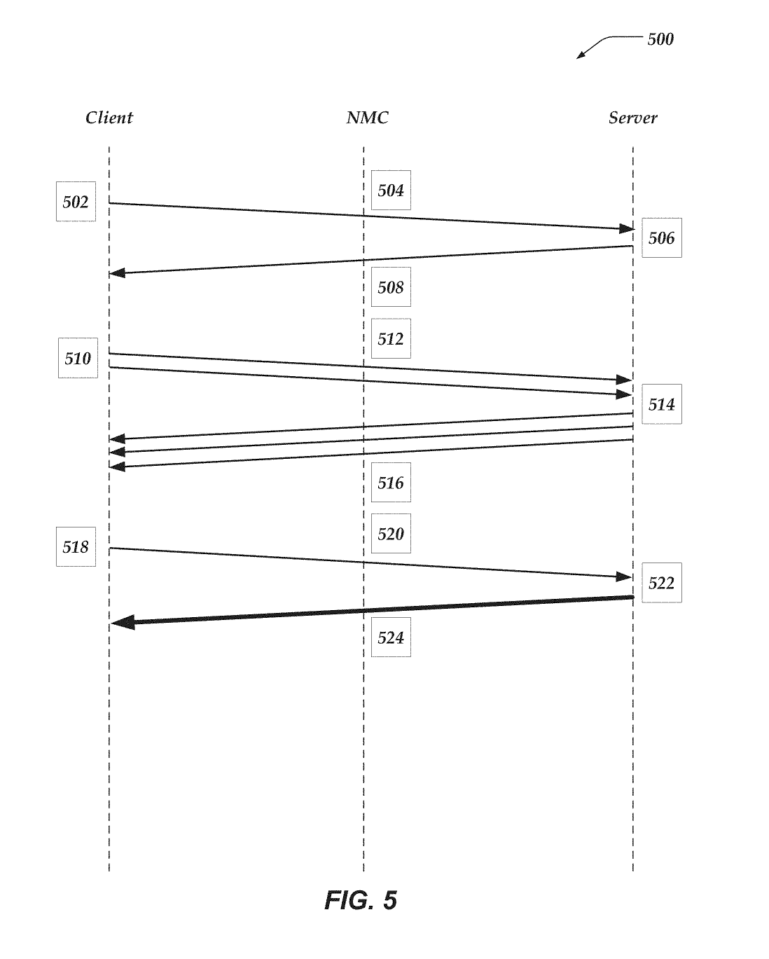

FIG. 5 illustrates a logical sequence diagram representing exemplary sequence 500 showing turn detection. In one or more of the various embodiments, sequence 500 illustrates network traffic exchanged by a client and a server with an NMC (e.g., NMC 408) disposed to monitor both directions of the network traffic.

At step 502, in one or more of the various embodiments, a client may be communicating over a network with a server. At step 504, in some of the various embodiments, the NMC may be arranged to monitor the network traffic from the client to the server. At step 506, in some embodiments, the server may respond based on the client communications. At step 508, the NMC may be arranged to monitor the network traffic from the server to the client.

In this example, the NMC may be arranged to characterize the traffic associated with steps 502-508 as uninteresting or routine communication based on one or more filters or rules. For example, this may be heartbeat/watchdog traffic periodically sent over the network.

At step 510, in one or more of the various embodiments, the client may send one or more network packets comprising a request (e.g., requests to download a file). At step 512, in some of the various embodiments, the NMC may observe the layer four behavior for the request. Accordingly, the NMC may not need to have protocol or application information associated with the request. At step 514, in some embodiments, the server may receive the request and prepare one or more responses. In this example, the server may perform various operations to authenticate the client and validate the requests; lookup up the file and prepare it for transfer; and begin sending the responses back to the client.

At step 516, in one or more of the various embodiments, the NMC may observe the layer four behavior for the responses. In some of the various embodiments, the NMC may apply one or more filters or rules to the network traffic based on the layer four behavior. In some of the various embodiments, the NMC may apply one or more count or temporal filters to determine a number of communications that the server sends within a particular time range following a certain number of communications from the client. In some embodiments, the NMC may apply one or more turn detection rules to detect the change in direction between steps 510 and 514 and, as a result, determine that a turn is occurring. Also, in some embodiments, the NMC may be configured to capture one or more portions of one or more packets associated with the detected turn.

At step 518, in one or more of the various embodiments, the client may send one or more network packets comprising another request (e.g., requests to download another file). At step 520, in some of the various embodiments, the NMC may observe the application behavior (e.g., layer seven) of the request. Accordingly, the NMC may have protocol or application information associated with the request. At step 522, in some embodiments, the server may receive the requests and prepare one or more responses. In this example, the server may perform various operations to authenticate the client and validate the requests; lookup up the file and prepare it for transfer; and begin sending the responses back to the client.

At step 524, in one or more of the various embodiments, the NMC may observe the application behavior (e.g., layer seven) for the response. In some of the various embodiments, the NMC may apply one or more filters or rules to the network traffic based on the application behavior (e.g., layer seven). In some of the various embodiments, the NMC may apply one or more protocol or application filters to determine whether the protocol or application associated with the request is known. In some embodiments, the NMC may apply one or more turn detection rules to detect the association between the request of step 518 and the response of step 522 (e.g., as in an HTTP request and response) and, as a result, determine that a turn is occurring. Additionally or alternatively, the NMC may apply one or more state detection rules to detect one or more anomalies between one or more expected states for the protocol or application and one or more detected states for the protocol or application. Also, in some embodiments, the NMC may be configured to capture one or more portions of one or more packets associated with the detected turn.

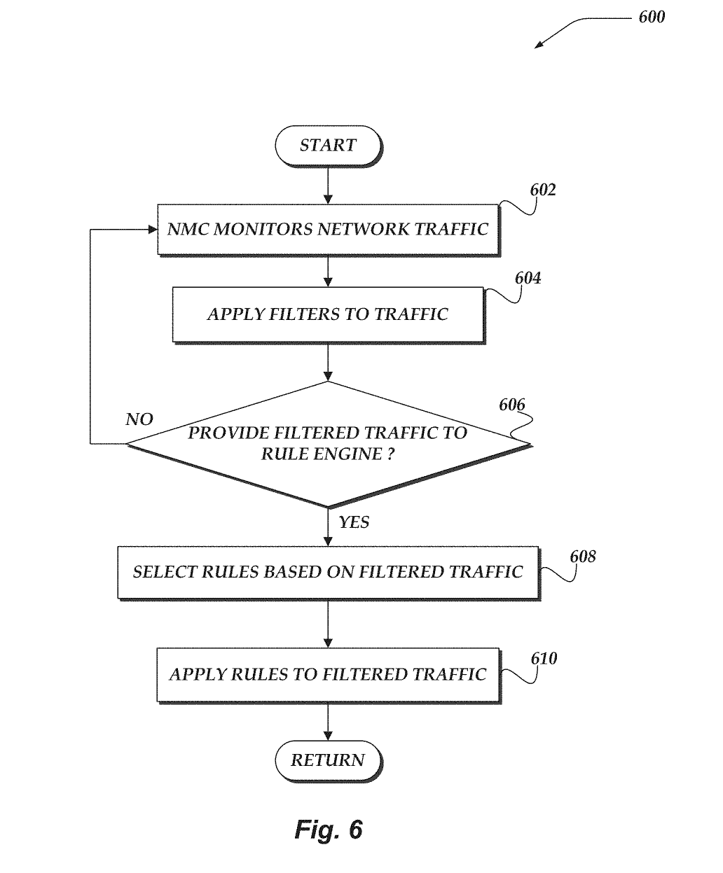

FIG. 6 shows an overview flowchart of exemplary process 600 for monitoring network traffic. After a start block, at block 602, in one or more of the various embodiments, an NMC (e.g., NMC 408) may be arranged to monitor network traffic.

At block 604, in one or more of the various embodiments, the NMC may apply one or more filters to the monitored network traffic as discussed above. At decision block 606, in one or more of the various embodiments, if the network traffic matches one or more criteria of one or more filters or combinations of filters, the filtered network traffic may be sent to one or more rule engines (e.g., client rule engine 214, rule engine 326, or the like) and control may flow to block 608; otherwise, control may loop back to block 602. In some of the various embodiments, applying the filters may be computationally less expensive than applying rules of the rule engines.

At block 608, in one or more of the various embodiments, the NMC may select one or more rules based on the filtered network traffic. In some of the various embodiments, the NMC may select one or more rules associated with the one or more filters or combinations of filters that were matched by the filtered network traffic. For example, if the network traffic includes communications involving one or more of a new client, new port, new protocol, new application, or the like, the NMC may select one or more rules associated with one or more of a new-client filter, a new-protocol filter, a new-application filter, the like, or a combination thereof.

In one or more of the various embodiments, each rule may be an object or data structure or each rule may include an object or data structure that is associated with one or more rule prologues and one or more rule actions. In some of the various embodiments, one or more rule prologues and one or more rule actions that are associated with the same rule may be included in the same table, different tables, the same file, different files, other objects, other data structures, or the like. In some embodiments, one or more objects or data structures that represent the one or more rules may include references or identifiers that indicate or reference which rule actions may be associated with which rule prologues for a given rule. In one or more of the various embodiments, two or more rules may share one or more of the same rule prologues. Also, in one or more of the various embodiments, two or more rules may share one or more of the same rule actions. In some embodiments, one or more rules, one or more rule prologues, one or more rule actions, identifiers, references, or the like, may be included in one or more configuration files, scripts, database tables, configuration registries, or the like.

At block 610, in one or more of the various embodiments, the NMC may apply the selected rules to the filtered network traffic. In some of the various embodiments, the NMC may provide the filtered network traffic to one or more other engines based on the application of the selected rules to the filtered network traffic. In some embodiments, the NMC may provide the filtered network traffic to one or more engines associated with the one or more rules that indicate that the filtered network traffic may be interesting or non-routine. In some embodiments, employing the one or more rule engines may be computationally less expensive than employing the one or more other engines. For example, if the application of the selected rules indicates that the filtered network traffic includes one or more layer four turns correlated with one or more layer seven turns, the NMC may provide the filtered network traffic to one or more universal payload analysis (UPA) engines to extract data from the filtered network traffic.

In one or more of the various embodiments, a UPA engine may be arranged to employ programmable configuration information, such as, programs, scripts, or the like, to parse protocols that are not supported natively by an NMC.

In some of the various embodiments, a UPA engine may monitor or analyze custom protocols in addition to natively supported protocols, such as by parsing the protocols, storing metrics for protocol activity, or the like. In some embodiments, the UPA engine may record header information for encapsulated payloads. In some embodiments, the NMC may continue operating until a user configures the NMC to terminate operation. Next, control may be returned to a calling process.

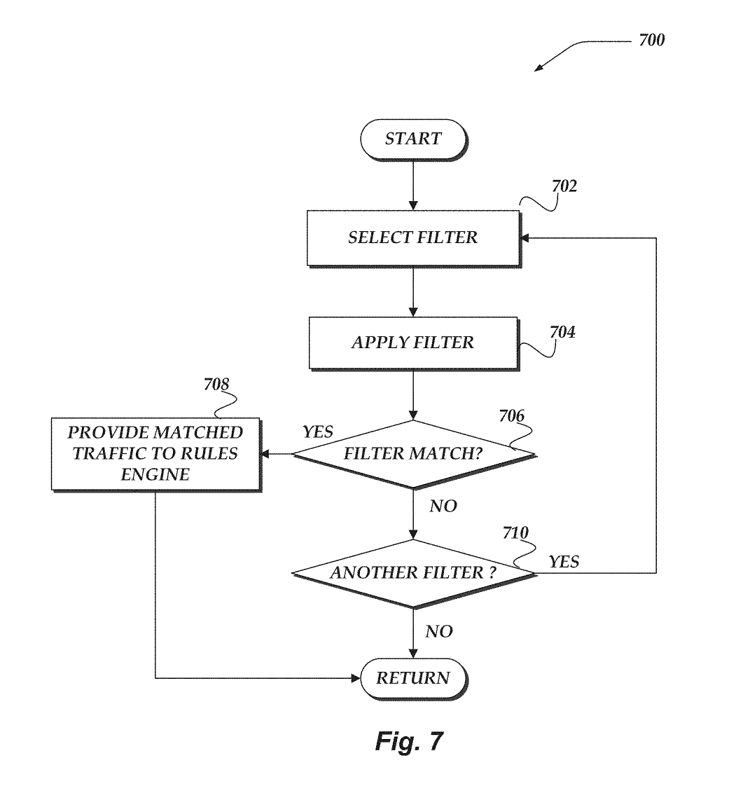

FIG. 7 illustrates a logical flow diagram of exemplary process 700 for applying one or more filters to monitored network traffic to determine if some or all of the monitored network traffic should be provided to a rules engine. After a start block, at block 702, in one or more of the various embodiments, an NMC, such as NMC 408, may be arranged to select a filter. In some of the various embodiments, the NMC may select the filter from a list of filters. In some embodiments, the NMC may select the filter based on a predetermined order or at random. In other embodiments, the NMC may select the filter based on whether a match was detected for a previously applied filter. In one or more of the various embodiments, NMCs may be arranged to select the one or more filters based on configuration information, policy rules, user input, or the like, or combination thereof.

In one or more of the various embodiments, a filter may include a single condition without deeper analysis of the traffic. In some of the various embodiments, the filters may include one or more of new-traffic filters, trusted-traffic filters, new-protocol filters, new-device filters, trusted-device filters, new-port filters, trusted-port filters, QoS-change filters, or the like. For example, filters for detecting new traffic or new devices may be arranged to identify network traffic or devices newly observed on a monitored network. Thus, in this example, if a new computer joins a network it may be considered a new device. Likewise, in some embodiments, the new computer's network traffic may be considered new network traffic.

In one or more of the various embodiments, filters for identifying new devices or new network traffic may be arranged to compare tuple information associated with the new device or new traffic to a list of seen or otherwise known devices or traffic. For example, in some embodiments, a filter may be arranged to filter traffic may be based on its source IP address, destination IP address, port, packet size, or the like.

In one or more of the various embodiments, one or more filters may be arranged to filter traffic absent packet inspection or deep packet inspection.

At block 704, in one or more of the various embodiments, the NMC may apply the selected filter to the monitored network traffic to determine if some or all of the monitored network traffic should be provided to a rules engine.

In some of the various embodiments, if the monitored network traffic includes or exhibits a characteristic that satisfies the condition of the filter, the NMC may determine that the monitored network traffic matches the criteria of the filter. For example, in some embodiments, traffic that includes communications to or from a new device may match criteria for a new-device filter. Alternatively, in some embodiments, if the characteristic of the monitored network traffic does not satisfy the condition of the filter, the NMC may determine that the monitored network traffic matches the criteria of the filter. Accordingly, in some embodiments, one or more filters may be arranged to be inclusive or exclusive. For example, in some embodiments, some trusted-port filters may be arranged to exclude traffic that is associated with one or more trusted ports. Likewise, in some embodiments, some trusted-port filters may be arranged to include network traffic that is associated with one or more trust ports.

At decision block 706, in one or more of the various embodiments, if one or more filters match the network traffic, control may flow to block 708; otherwise control may flow to decision block 710.

At block 708, in one or more of the various embodiments, the matched network traffic may be provided to a rules engine for further processing, inspection, or analysis.

At decision block 710, in one or more of the various embodiments, if the monitored network traffic matches the filter or if there are no more filters to apply, control may be returned to a calling process; otherwise, if the monitored network traffic does not match the filter or if there are more filters to apply, control may loop back to block 702. In some embodiments, the NMC may continue operating until a user configures the NMC to terminate operation. Next, control may be returned to a calling process.

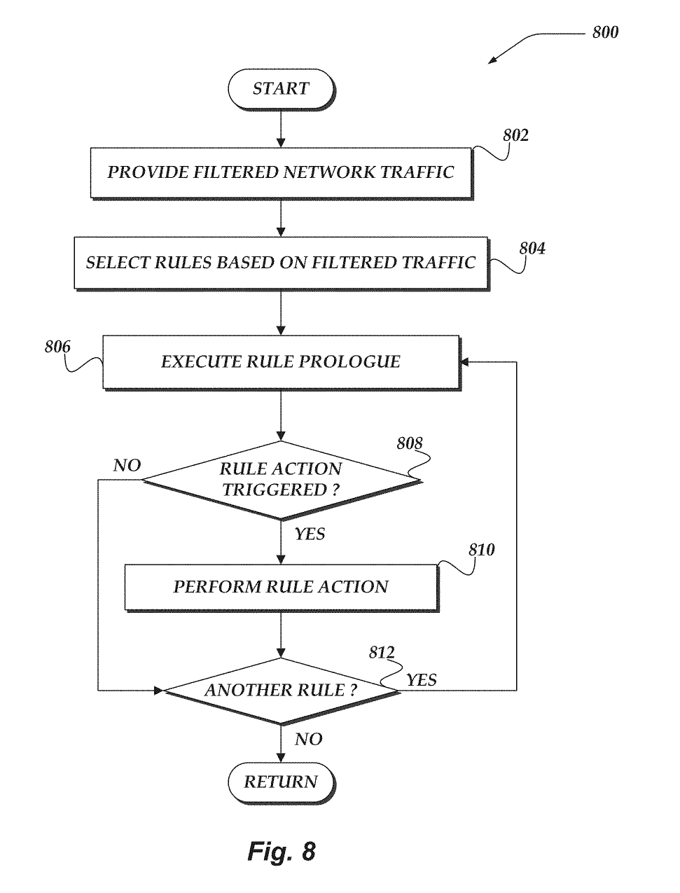

FIG. 8 shows a logical flow diagram of exemplary process 800 for employing one or more rule engines, such as client rule engine 214, rule engine 326, or the like, to analyze filtered network traffic. After a start block, at block 802, in one or more of the various embodiments, an NMC, such as NMC 408, may be arranged to provide filtered network traffic to one or more rule engines as discussed above. At block 804, in one or more of the various embodiments, the rule engine may select one or more rules based on the filtered network traffic. In some of the various embodiments, the rule engine may select rules associated with the one or more filters or combinations of filters that were matched by the filtered network traffic. In one or more of the various embodiments, NMCs may be arranged to employ the rule engine to select one or more rules based on configuration or policy rules. In one or more of the various embodiments, criteria for selecting rules may include one or more characteristics of the filtered network traffic, such as tuple information, payload content, communication protocol, application protocol, bit rate, packet size, time-of-day, or the like, or combination thereof.

In one or more of the various embodiments, rules may be arranged to include one or more associated prologues that, if satisfied, trigger one or more rule actions. In some of the various embodiments, one or more of the prologues may include predicate logic, propositional logic, or the like. In some embodiments, the rules may include one or more prologues to detect, classify, or track one or more of turns, state anomalies, tunneled protocols, signature behaviors, patterns, pipelining, changes in encryption, changes in type of service (ToS), envelopes, changes in content type (e.g., private content such as social security number, or the like), string matches, regex matches, or the like.

In one or more of the various embodiments, one or more rule prologues may be arranged to make determinations based on more than one network packets, buffered network traffic, network packets from different network flows, traffic characteristics associated with different OSI layers, or the like.

In one or more of the various embodiments, a rule prologues may be arranged to identify patterns of content values contained in a sequence of network packets. For example, a rule prologue may be arranged to identify a multi-step protocol handshake for particular network protocol, network applications, or the like.

At block 806, in one or more of the various embodiments, the rule engine may execute one or more rule prologues for a selected rule. At decision block 808, if the filtered network traffic satisfies the executed rule prologue, the rule engine may determine that a rule action is triggered, and control may flow to block 810; otherwise, control may flow to decision block 812.

At block 810, in one or more of the various embodiments, the rule engine may perform one or more rule actions. In some of the various embodiments, a rule action associated with a selected rule may cause the NMC to perform various defined actions. In some embodiments, the rule actions may include providing the filtered network traffic to one or more other engines as discussed above, such as UPA engines, advertisement selection engines, variable pricing engines, resource allocation engines, or the like. In some embodiments, a rule action associated with a selected rule may include setting one or more values for one or more rule prologues associated with a subsequently applied rule.

In one or more of the various embodiments, each rule may be an object or data structure or each rule may include an object or data structure that is associated with one or more rule prologues and one or more rule actions. In some of the various embodiments, one or more rule prologues and one or more rule actions that are associated with the same rule may be included in the same table, different tables, the same file, different files, other objects, other data structures, or the like. In some embodiments, one or more objects or data structures that represent the one or more rules may include references or identifiers that indicate or reference which rule actions may be associated with which rule prologues for a given rule. In one or more of the various embodiments, two or more rules may share one or more of the same rule prologues. Also, in one or more of the various embodiments, two or more rules may share one or more of the same rule actions. In some embodiments, one or more rules, one or more rule prologues, one or more rule actions, identifiers, references, or the like, may be included in one or more configuration files, scripts, database tables, configuration registries, or the like.

At decision block 812, in one or more of the various embodiments, if there are no more selected rules to apply, control may be returned to a calling process; otherwise, control may loop back to block 806. In some of the various embodiments, one or more results of executing the rule prologue of the prior rule, performing the rule action of the prior rule, or the like may be provided as one or more inputs when executing a rule prologue of a subsequently applied rule. In some embodiments, the rule engine may continue operating until a user configures the rule engine to terminate operation. Next, control may be returned to a calling process.

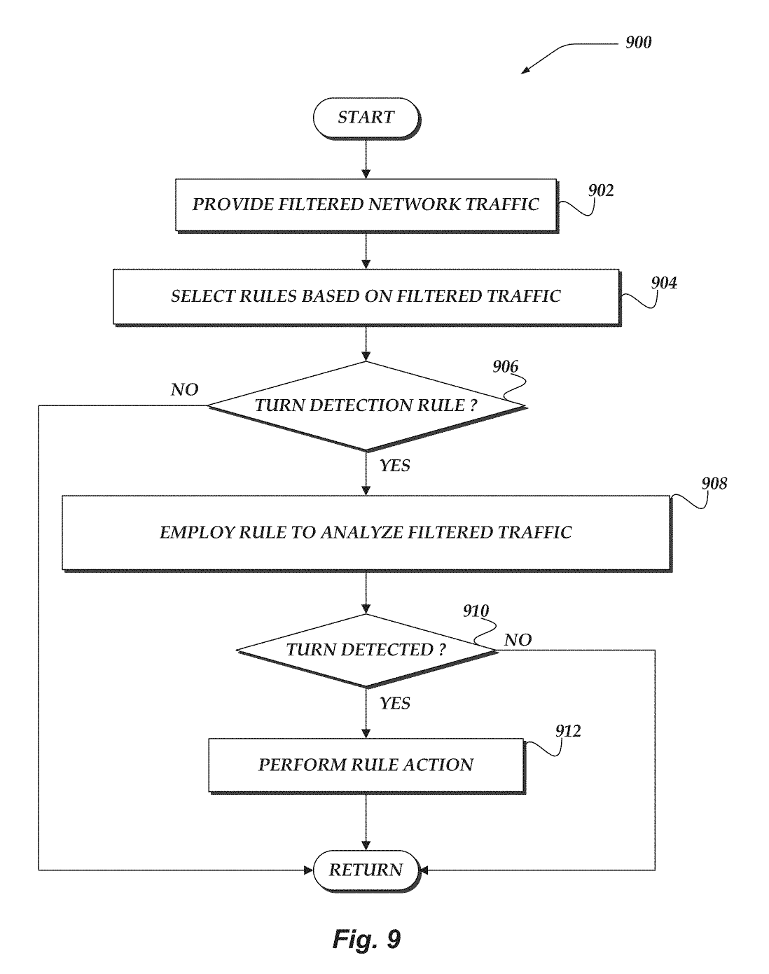

FIG. 9 illustrates a logical flow diagram of exemplary process 900 for employing one or more rule engines, such as client rule engine 214, rule engine 326, or the like, to detect turns in filtered network traffic. After a start block, at block 902, in one or more of the various embodiments, an NMC, such as NMC 408, may be arranged to provide filtered network traffic to one or more rule engines as discussed above. At block 904, in one or more of the various embodiments, the rule engine may select one or more rules based on the filtered network traffic. In some of the various embodiments, the rule engine may select rules associated with the one or more filters or combinations of filters that were matched by the filtered network traffic. In one or more of the various embodiments, NMCs may be arranged to employ the rule engine to select one or more rules based on configuration or policy rules. In one or more of the various embodiments, criteria for selecting rules may include one or more characteristics of the filtered network traffic, such as tuple information, payload content, communication protocol, application protocol, bit rate, packet size, time-of-day, or the like, or combination thereof.

At decision block 906, in one or more of the various embodiments, if the selected rules include one or more turn detection rules, control may flow to block 908; otherwise, control may return to a calling process. In one or more of the various embodiments, turn detection rules may be identified based on labels, tags, identifiers, operational characteristics, or the like, that may be included in configuration information, the rule definition, or the like.

At block 908, in one or more of the various embodiments, the rule engine may employ one or more turn detection rules to analyze the filtered network traffic. In some of the various embodiments, one or more turn detection rules may include one or more rule prologues associated with various OSI layers. In some embodiments, one or more rule prologues may be arranged to identify or detect layer four turns in the filtered network traffic. In some embodiments, one or more other rule prologues may be associated with detecting application behavior (e.g., layer seven) that may be used to identify or discover turns in the filtered network traffic. In some embodiments, one or more other rule prologues may be arranged to correlate two or more different OSI layers, such as layer four behavior and application behavior, or the like, to identify or discover one or more turns in the filtered network traffic.

In one or more of the various embodiments, the rule engine may employ the one or more turn detection rules to analyze behavior associated with lower level OSI layers (e.g., layer four) to determine if the filtered network traffic includes a change in communication direction. For example, in some embodiments, the rule engine may be arranged to detect turns by analyzing the filtered network traffic to determine if data is flowing in one direction (e.g., from network endpoint A to network endpoint B) followed by data flowing in the other direction (e.g., from network endpoint B to network endpoint A). Continuing with this example, in some embodiments, if a change in the amount of data flowing in one direction compared to the amount data flowing in the other direction exceeds one or more defined thresholds, the one or more rules may indicate that a turn has been detected or discovered.

Likewise, in one or more of the various embodiments, the rule engine may employ one or more turn detection rules associated with application behavior (e.g., OSI layer seven) to determine if the filtered network traffic includes one or more requests and one or more responses to the one or more requests that may correspond with a turn. In some of the various embodiments, the rule engine may analyze communications from clients to determine if the communications include requests based on various characteristics of the network traffic, such as packet content, tuple information, timing, quantity of data, or the like. In some embodiments, the rule engine may analyze communications from servers to determine if the communications include responses to the requests based on various characteristics of the network traffic, such as packet content, tuple information, timing, quantity of data, or the like. In some embodiments, one or more other rule prologues may correlate layer four behavior and application behavior to determine if both behaviors indicate one or more turns.

At decision block 910, in one or more of the various embodiments, if one or more turns are detected, control may flow to block 912; otherwise, control may be returned to a calling process.

At block 912, in one or more of the various embodiments, the rule engine may perform one or more rule actions as discussed above. In one or more of the various embodiments, discovering turns may identify important, critical, or interesting portions of communication session. Accordingly, in one or more of the various embodiments, it may be advantageous to arranged rules or rule actions to be performed on or around the occurrences of turns. For example, in some embodiments, a packet capture system may be arranged to capture and store network packets that occur near in time to a turn. In some embodiments, the rule engine may continue operating until a user configures the rule engine to terminate operation. Next, control may be returned to a calling process.

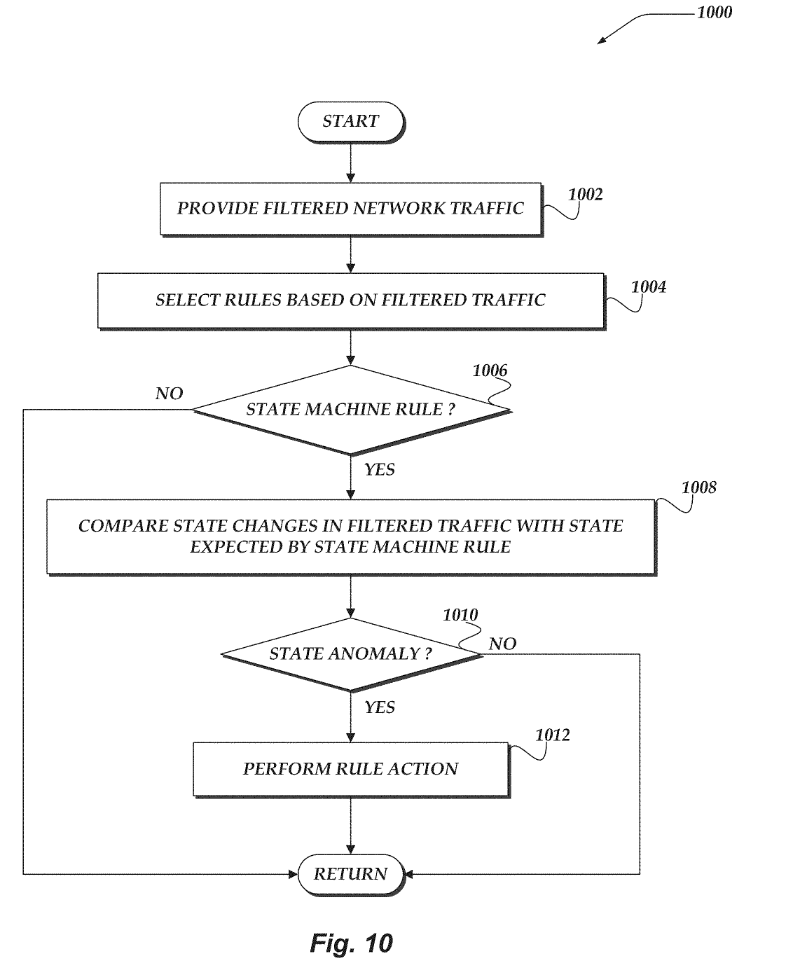

FIG. 10 illustrates a logical flow diagram of exemplary process 1000 for employing one or more rule engines, such as client rule engine 214, rule engine 326, or the like, to detect anomalies in filtered network traffic. After a start block, at block 1002, in one or more of the various embodiments, an NMC, such as NMC 408, may be arranged to provide filtered network traffic to one or more rule engines as discussed above. At block 1004, in one or more of the various embodiments, the rule engine may select one or more rules based on the filtered network traffic. In some of the various embodiments, the rule engine may select rules associated with the one or more filters or combinations of filters that were matched by the filtered network traffic. In one or more of the various embodiments, NMCs may be arranged to employ the rule engine to select one or more rules based on configuration or policy rules. In one or more of the various embodiments, criteria for selecting rules may include one or more characteristics of the filtered network traffic, such as tuple information, payload content, communication protocol, application protocol, bit rate, packet size, time-of-day, or the like, or combination thereof.

At decision block 1006, in one or more of the various embodiments, if the selected rules include one or more state machine rules, control may flow to block 1008; otherwise, control may return to a calling process. In one or more of the various embodiments, state machine rules may be identified based on labels, tags, identifiers, operational characteristics, or the like, that may be included in configuration information, the rule definition, or the like.

At block 1008, in one or more of the various embodiments, the rule engine may employ one or more state machine rules to compare one or more state changes in the filtered network traffic with one or more state changes expected by the one or more state machine rules to identify or detect anomalies in the filtered network traffic.

In some of the various embodiments, one or more state machine rules may include one or more rule prologues to analyze or monitor one or more state changes associated with one or more known protocols or known applications. In one or more of the various embodiments, one or more state machines may be arranged to model the expected states and transitions for a given communication protocol or application. In one or more of the various embodiments, one or more rule prologues may be arranged to compare observed state transitions with expected state transitions to determine if one or more anomalies may have occurred.

In one or more of the various embodiments, the one or more rule prologues may be arranged to transition one or more state machines from one state to another based on one or more characteristics of the filtered network traffic to determine one or more expected states for the one or more filtered network traffic.

In some embodiments, the one or more rule prologues may be arranged to compare one or more actual states associated with the filtered network traffic to the one or more expected states. In some embodiments, if the one or more actual states associated with the filtered network traffic are different from the one or more expected states, the one or more rule prologues may be arranged to indicate that one or more anomalies in the filtered network traffic have been discovered.

In some embodiments, one or more other rule prologues may be arranged to correlate expected states or actual states of filtered network traffic at two or more different OSI layers, such as OSI layer four behavior, application behavior, encryption behavior, or the like, to identify or discover one or more anomalies in the filtered network traffic.

At decision block 1010, in one or more of the various embodiments, if one or more anomalies are detected, control may flow to block 1012; otherwise, control may be returned to a calling process.

At block 1012, in one or more of the various embodiments, the rule engine may perform one or more rule actions as discussed above. In one or more of the various embodiments, discovering anomalies may identify important, critical, or interesting portions of communication session. Accordingly, in one or more of the various embodiments, it may be advantageous to arranged rules or rule actions to be performed on or around the occurrences of anomalies. For example, in some embodiments, a packet capture system may be arranged to capture and store network packets that occur near in time to an anomaly. In some embodiments, the rule engine may continue operating until a user configures the rule engine to terminate operation. Next, control may be returned to a calling process.

It will be understood that each block of the flowchart illustration, and combinations of blocks in the flowchart illustration, can be implemented by computer program instructions. These program instructions may be provided to one or more processors to produce a machine, such that the instructions, which execute on the one or more processors, create means for implementing the actions specified in the flowchart block or blocks. The computer program instructions may be executed by the one or more processors to cause a series of operational steps to be performed by the one or more processors to produce a computer-implemented process such that the instructions, which execute on the one or more processors to provide steps for implementing the actions specified in the flowchart block or blocks. The computer program instructions may also cause at least some of the operational steps shown in the blocks of the flowchart to be performed in parallel and/or concurrently by the one or more processors and/or one or more computers. Moreover, some of the steps may also be performed across more than one processor or computer. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

Further, in one or more embodiments (not shown in the figures), the logic in the illustrative flowcharts may be executed using one or more embedded logic hardware devices instead of one or more CPUs, such as an Application Specific Integrated Circuits (ASICs), Field Programmable Gate Arrays (FPGAs), Programmable Array Logic chips (PALs), or the like, or combination thereof. The embedded one or more logic hardware devices may directly execute their embedded logic to perform actions. In at least one embodiment, one or more microcontrollers may be arranged as system-on-a-chip (SOCs) to directly execute their own locally embedded logic to perform actions and access their own internal memory and their own external Input and Output Interfaces (e.g., hardware pins and/or wireless transceivers) to perform actions described herein.

1. A method for monitoring one or more network flows, wherein one or more processors in a network computer that execute instructions for a plurality of applications that perform actions, comprising:
employing a monitoring engine application to compare one or more characteristics of the one or more monitored network flows to one or more criteria, wherein the one or more criteria are provided by one or more filters;
employing a filter engine application to perform further actions including:
filtering network traffic based on the one or more filters and the comparison, wherein one or more universal payload analysis (UPA) engines are employed to analyze protocols that are one or more custom or unsupported natively by the network computer and extract packet payload data from the filtered network traffic, wherein the analysis includes employing one or more state machines to classify the protocols by mimicking state changes in the monitored network flows; and
employing a rule engine application to perform further actions, including:
providing one or more rules based on the filtered network traffic, wherein each rule is associated with one or more rule prologues and one or more rule actions;
executing the one or more rule prologues on the filtered network traffic to provide one or more satisfied rule prologues, wherein the one or more satisfied rule prologues includes indicating that a turn is occurring on a monitored network flow of packets between one or more servers and clients based on detection of one or more of a response-request data pattern or a new transaction data pattern, wherein the indication of the turn identifies the detected pattern regarding the monitored network flow in the packets' payload data; and
executing one or more of the one or more rule actions based on the one or more satisfied rule prologues, wherein the one or more executed rule actions and the one or more satisfied rule prologues are each associated with a same rule.

2. The method of claim 1, wherein providing the one or more rules, further comprises, providing the one or more rules based on which of the one or more filters are associated with the filtered network traffic.

3. The method of claim 1, wherein the one or more criteria provided by the one or more filters include one or more discoveries of one or more new network flows or one or more new network devices on a monitored network.

4. The method of claim 1, wherein executing the one or more rule prologues on the filtered network traffic, further comprises, inspecting payload contents of one or more network packets that are included in the filtered network traffic.

5. The method of claim 1, wherein executing the one or more rule prologues on the filtered network traffic, further comprises, employing the one or more state machines to compare one or more state transitions in the filtered network traffic to one or more expected state transitions.

6. The method of claim 1, wherein the one or more criteria provided by the one or more filters include one or more of a network protocol, an application protocol, an application type, a traffic rate, or tuple information of the one or more monitored network flows.

7. The method of claim 1, wherein executing the one or more of the one or more rule actions further comprises, providing one or more portions of the filtered network traffic to the one or more universal payload analysis (UPA) engines.

8. A system for monitoring one or more network flows in a network comprising:
a network computer, comprising:
a transceiver that communicates over the network;
a memory that stores at least instructions; and
one or more processors that execute instructions for a plurality of applications that perform actions, including:
employing a monitoring engine application to compare one or more characteristics of the one or more monitored network flows to one or more criteria, wherein the one or more criteria are provided by one or more filters;
employing a filter engine application to perform further actions including:
filtering network traffic based on the one or more filters and the comparison, wherein one or more universal payload analysis (UPA) engines are employed to analyze protocols that are one or more of custom or unsupported natively by the network computer and extract packet payload data from the filtered network traffic, wherein the analysis includes employing one or more state machines to classify the protocols by mimicking state changes in the monitored network flows; and
employing a rule engine application to perform further actions, including:
providing one or more rules based on the filtered network traffic, wherein each rule is associated with one or more rule prologues and one or more rule actions;
executing the one or more rule prologues on the filtered network traffic to provide one or more satisfied rule prologues, wherein the one or more satisfied rule prologues includes indicating that a turn is occurring on a monitored network flow of packets between one or more servers and clients based on detection of one or more of a response-request data pattern or a new transaction data pattern, wherein the indication of the turn identifies the detected pattern regarding the monitored network flow in the packets' payload data; and
executing one or more of the one or more rule actions based on the one or more satisfied rule prologues, wherein the one or more executed rule actions and the one or more satisfied rule prologues are each associated with a same rule; and
a client computer, comprising:
a transceiver that communicates over the network;
a memory that stores at least instructions; and
one or more processors that execute instructions that perform actions, including:
providing one or more portions of the one or more monitored network flows.

9. The system of claim 8, wherein providing the one or more rules, further comprises, providing the one or more rules based on which of the one or more filters are associated with the filtered network traffic.

10. The system of claim 8, wherein the one or more criteria provided by the one or more filters include one or more discoveries of one or more new network flows or one or more new network devices on a monitored network.

11. The system of claim 8, wherein executing the one or more rule prologues on the filtered network traffic, further comprises, inspecting payload contents of one or more network packets that are included in the filtered network traffic.

12. The system of claim 8, wherein executing the one or more rule prologues on the filtered network traffic, further comprises, employing the one or more state machines to compare one or more state transitions in the filtered network traffic to one or more expected state transitions.

13. The system of claim 8, wherein the one or more criteria provided by the one or more filters include one or more of a network protocol, an application protocol, an application type, a traffic rate, or tuple information of the one or more monitored network flows.

14. The system of claim 8, wherein executing the one or more of the one or more rule actions further comprises, providing one or more portions of the filtered network traffic to the one or more universal payload analysis (UPA) engines.

15. A processor readable non-transitory storage media that includes instructions for monitoring one or more network flows with a plurality of applications, wherein execution of the instructions by one or more processors causes the plurality of applications to perform actions, comprising:
employing a monitoring engine application to compare one or more characteristics of the one or more monitored network flows to one or more criteria, wherein the one or more criteria are provided by one or more filters;
employing a filter engine application to perform further actions including:
filtering network traffic based on the one or more filters and the comparison, wherein one or more universal payload analysis (UPA) engines are employed to analyze protocols that are one or more of custom or unsupported natively by the network computer and extract packet payload data from the filtered network traffic, wherein the analysis includes employing one or more state machines to classify the protocols by mimicking state changes in the monitored network flows; and
employing a rule engine application to perform further actions, including:
providing one or more rules based on the filtered network traffic, wherein each rule is associated with one or more rule prologues and one or more rule actions;
executing the one or more rule prologues on the filtered network traffic to provide one or more satisfied rule prologues, wherein the one or more satisfied rule prologues includes indicating that a turn is occurring on a monitored network flow of packets between one or more servers and clients based on detection of one or more of a response-request data pattern or a new transaction data pattern, wherein the indication of the turn identifies the detected pattern regarding the monitored network flow in the packets' payload data; and
executing one or more of the one or more rule actions based on the one or more satisfied rule prologues, wherein the one or more executed rule actions and the one or more satisfied rule prologues are each associated with a same rule.

16. The media of claim 15, wherein providing the one or more rules, further comprises, providing the one or more rules based on which of the one or more filters are associated with the filtered network traffic.

17. The media of claim 15, wherein the one or more criteria provided by the one or more filters include one or more discoveries of one or more new network flows or one or more new network devices on a monitored network.

18. The media of claim 15, wherein executing the one or more rule prologues on the filtered network traffic, further comprises, inspecting payload contents of one or more network packets that are included in the filtered network traffic.

19. The media of claim 15, wherein executing the one or more rule prologues on the filtered network traffic, further comprises, employing the one or more state machines to compare one or more state transitions in the filtered network traffic to one or more expected state transitions.

20. The media of claim 15, wherein the one or more criteria provided by the one or more filters include one or more of a network protocol, an application protocol, an application type, a traffic rate, or tuple information of the one or more monitored network flows.

21. The media of claim 15, wherein executing the one or more of the one or more rule actions further comprises, providing one or more portions of the filtered network traffic to the one or more universal payload analysis (UPA) engines.

22. A network computer for monitoring one or more network flows, comprising:
a transceiver that communicates over the network;
a memory that stores at least instructions; and
one or more processors that execute instructions for a plurality of applications that perform actions, including:
employing a monitoring engine application to compare one or more characteristics of the one or more monitored network flows to one or more criteria, wherein the one or more criteria are provided by one or more filters;
employing a filter engine application to perform further actions including:
filtering network traffic based on the one or more filters and the comparison, wherein one or more universal payload analysis (UPA) engines are employed to analyze protocols that are one or more of custom or unsupported natively by the network computer and extract packet payload data from the filtered network traffic, wherein the analysis includes employing one or more state machines to classify the protocols by mimicking state changes in the monitored network flows; and
employing a rule engine application to perform further actions, including:
providing one or more rules based on the filtered network traffic, wherein each rule is associated with one or more rule prologues and one or more rule actions;
executing the one or more rule prologues on the filtered network traffic to provide one or more satisfied rule prologues, wherein the one or more satisfied rule prologues includes indicating that a turn is occurring on a monitored network flow of packets between one or more servers and clients based on detection of one or more of a response-request data pattern or a new transaction data pattern, wherein the indication of the turn identifies the detected pattern regarding the monitored network flow in the packets' payload data; and
executing one or more of the one or more rule actions based on the one or more satisfied rule prologues, wherein the one or more executed rule actions and the one or more satisfied rule prologues are each associated with a same rule.

23. The network computer of claim 22, wherein providing the one or more rules, further comprises, providing the one or more rules based on which of the one or more filters are associated with the filtered network traffic.

24. The network computer of claim 22, wherein the one or more criteria provided by the one or more filters include one or more discoveries of one or more new network flows or one or more new network devices on a monitored network.

25. The network computer of claim 22, wherein executing the one or more rule prologues on the filtered network traffic, further comprises, inspecting payload contents of one or more network packets that are included in the filtered network traffic.

26. The network computer of claim 22, wherein executing the one or more rule prologues on the filtered network traffic, further comprises, employing the one or more state machines to compare one or more state transitions in the filtered network traffic to one or more expected state transitions.

27. The network computer of claim 22, wherein the one or more criteria provided by the one or more filters include one or more of a network protocol, an application protocol, an application type, a traffic rate, or tuple information of the one or more monitored network flows.

28. The network computer of claim 22, wherein executing the one or more of the one or more rule actions further comprises, providing one or more portions of the filtered network traffic to the one or more universal payload analysis (UPA) engines.
